(19) United States
(12) Patent Application Publication
(10) Pub. No.: US 2024/0337395 A1
(43) Pub. Date: Oct. 10, 2024

(54) Ductwork System for Modulating Conditioned Air

(71) Applicant: Robert Joe ALDERMAN, Poteet, TX (US)

(72) Inventor: Robert Joe ALDERMAN, Poteet, TX (US)

(21) Appl. No.: 18/748,632

(22) Filed: Jun. 20, 2024

Related U.S. Application Data
(63) Continuation-in-part of application No. 17/359,590, filed on Jun. 27, 2021.
(60) Provisional application No. 63/103,341, filed on Aug. 3, 2020.

(51) Int. Cl. F24F 5/00; F24F 13/02

(52) U.S. Cl. CPC F24F 5/0021; F24F 13/0263

(57) ABSTRACT

A ductwork system including a temperature modulating blanket with phase change material. The system allows for attic installation of ductwork while substantially avoiding effects of excessive temperatures and temperature gradients of the attic space on conditioned air run through the ductwork. Thus, smaller HVAC and overall power requirements may be realized for air conditioning applications in structural facilities. This may be of particular benefit for structural facilities retrofitted with HVAC systems where attic space is more likely to be made greater use of for accommodating ductwork.

### PRIORITY CLAIM/CROSS REFERENCE TO RELATED APPLICATION(S)

This Patent Document claims priority under 35 U.S.C. § 120 as a Continuation-In-Part of U.S. Utility application Ser. No. 17/359,590, filed Jun. 27, 2021 and entitled, “Ductwork System for Modulating Conditioned Air” and under 35 U.S.C. § 119 to U.S. Provisional App. Ser. No. 63/103,341, filed Aug. 3, 2020 and entitled, “Phase Change Material Protected Attic Ductwork”, both of which are incorporated herein by reference in their entireties.

### BACKGROUND

Storage units, garages, aircraft hangars, warehouses, portions of data centers and a host of other facilities that are used more so for housing goods and equipment than for human activity are often left without any climate control capabilities. Furthermore, older and more historic homes that are meant for human habitation may predate modern central air conditioning systems. Regardless, the decision is often made to convert such a facility to one that is equipped with a central air system. This may be for the purpose of updating an older home, converting a storage container to a housing unit for human habitation, for rendering a storage facility “climate-controlled” or a variety of other purposes.

As used herein, the term “central air” or “central air conditioning system” or other similar terminology, is meant to indicate a system in which air is cooled at a central location and distributed to and from rooms by one or more fans and ductwork. The work of the air conditioner compressor is utilized to facilitate conditioned air through the network and to various rooms serviced by the network of ductwork which channels the air as suggested.

A variety of challenges are presented when undertaking the task of converting a facility without central air to one that is equipped with central air. Specifically, the ductwork which is run from room to room of the facility may take a somewhat tortuous route given that the facility was originally designed without a layout meant to accommodate channelized air. By way of contrast, the compressor or fan equipment may be located at a centralized position, perhaps even external to the facility. Thus, the fact that the facility is not specifically tailored to accommodate this particular equipment may not present as much of a challenge. However, the need to wind ductwork throughout the facility from a central compressor location, for example, may not be avoided.

When it comes to retrofitting old homes with central air, the ductwork not only faces the tortuous routing from room to room without any pre-planned accommodation, but this tortuous routing often includes winding ductwork through attic space in the dwelling. That is, given the lack of any pre-planned accommodation for the ductwork, open attic space above rooms of the dwelling offers an attractive solution when it comes to ductwork installation. For example, in a single-story dwelling, a vertical route to the attic from the compressor location may allow for servicing of all dwelling rooms by installing the ductwork in the attic above the rooms.

Unfortunately, while attic space provides a convenient location for a retrofitted installation of ductwork to service rooms there-below, it is attic space. That is, depending on the time of year or relative latitude, the air in the attic may become quite hot during the day. For example, it would not be uncommon for attic space of a dwelling in the southern part of the U.S. to reach 155° F. during a mid-summer day.

Conditioned air routed through the ductwork of a central air system may be in the neighborhood of 55° F., for example. With reference to the example above, with ductwork routed through 155° F. attic space, a 100° F. differential may be present between the interior and exterior of the ductwork. This is a tremendous variance that is not easily overcome, even with the latest and most energy efficient conventional ductwork materials available. Indeed, it is not uncommon to see a 20-30% loss in output on an average summer day in the southern part of the U.S., for example.

### SUMMARY

A system for modulating temperature within ductwork located in an attic space is disclosed. The system includes ductwork for channeling conditioned air through attic space which itself is subject to a gradient of uneven temperatures even as measured against a height of the ductwork. A temperature modulating blanket is secured to the ductwork and accommodates a phase change material with a predetermined melting range for minimizing a total amount of heat reaching the conditioned air in the ductwork. The blanket also serves to minimize a range of the gradient of uneven temperature reaching the conditioned air from the attic space.

### BRIEF DESCRIPTION OF THE DRAWINGS

Implementations of various structure and techniques will hereafter be described with reference to the accompanying drawings. It should be understood, however, that these drawings are illustrative and not meant to limit the scope of claimed embodiments.

FIG. 1A is a side cross-sectional view of a structural facility with attic space accommodating ductwork with a temperature modulating blanket installed thereon.

FIG. 1B is a side cross-sectional, schematic view of ductwork wrapped with a temperature modulating blanket for placement in attic space.

FIG. 2A is a schematic cross-section of the temperature modulating blanket of FIG. 1B exposed to daytime attic temperatures above a melting point of phase change material in the blanket.

FIG. 2B is a schematic cross-section of the temperature modulating blanket of FIG. 2A exposed to evening attic temperatures below a melting point of the phase change material.

FIG. 3A is a perspective view of an embodiment of the temperature modulating blanket as supplied for use in wrapping of ductwork.

FIG. 3B is a cross-sectional view of the temperature modulating blanket of FIG. 3A revealing multilayered detail.

FIG. 4 is a perspective view of an embodiment of a manufacturing equipment for the temperature modulating blanket.

FIG. 5 is a flow-chart summarizing an embodiment of utilizing a temperature modulating blanket with a ductwork system in an attic of a structural facility.

### DETAILED DESCRIPTION

Embodiments are described with reference to the use of a temperature modulating blanket in the context of ductwork located in attic space. Specifically, an air conditioned retrofit of an old storage unit, previously lacking full HVAC capacity, is illustrated. The facility is retrofitted with a suspended ceiling accommodating ductwork in an attic space thereover to support a conditioned air network through the facility. A temperature modulating blanket is utilized over the suspended ceiling and notably around the ductwork. In spite of the particular facility illustrated, a variety of other facility types may take advantage of embodiments of a blanket as detailed herein. This may even include utilizing such a blanket being employed in previously fully HVAC equipped facilities or incorporating such blankets in walls and other locations throughout facilities, not limited to ceiling-type areas. For embodiments herein, so long as the blanket is utilized in connection with ductwork positioned in attic space, appreciable benefit may be realized. This, along with other features detailed, provides a system that allows for effective and efficient use of ductwork for conditioned air in circumstances where attic space is utilized for ease of installation. As used herein, the term “blanket” is not meant to infer any particular shape or structural arrangement. Indeed, any device, assembly or structure that incorporates phase change material may be considered a “blanket” as the term is used herein.

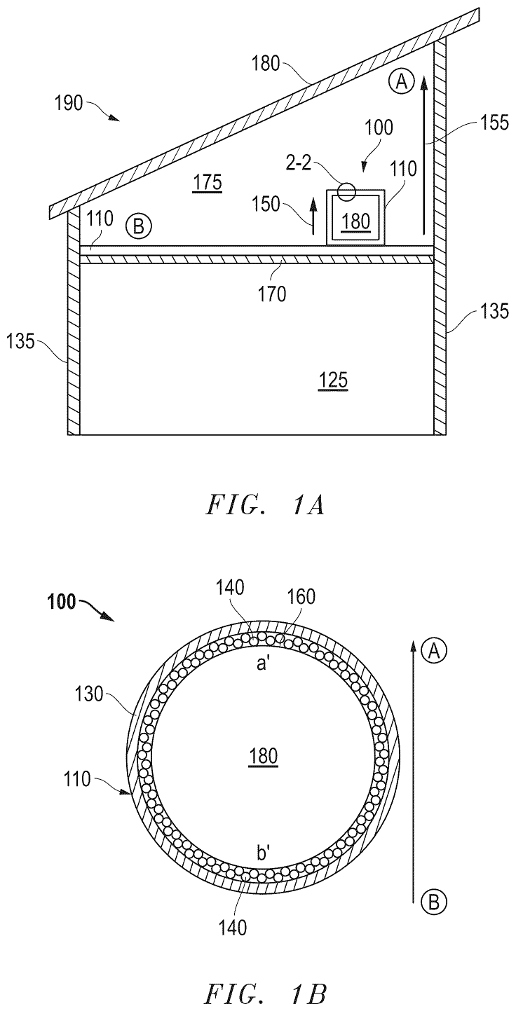

Referring specifically now to FIG. 1A, with some added reference to 1B, a side cross-sectional view of a structural facility 190 is illustrated with attic space 175 accommodating a ductwork system 100 that includes ductwork 160 with a temperature modulating blanket 110 installed thereon. In the embodiment illustrated, the system 100 is rectangular or square shaped due to the underlying morphology of the structurally supportive ductwork 160. However, a more circular conduit morphology may be utilized as shown in FIG. 1B. Indeed, the system 100 may be somewhat flexible and conformable, so long as adequate support is available for maintaining a channel 180 to accommodate a flow of conditioned air as needed.

Continuing with reference to FIG. 1A, the structural facility 190 accommodates a suspended ceiling 170 and walls 135. In the embodiment shown, the ceiling 170 is outfitted with a temperature modulating blanket 110 which may be used to help regulate temperature differential between the attic space 175 and the facility space 125 below that may be for storage or habitation. The direct exposure of the blanket 110 to the attic space 175 may be of benefit given that the attic space 175 may display dramatic swings in temperature throughout a given diurnal cycle. That is, with particularly high daytime temperatures giving way to comparatively low temperatures at night, there are daylight periods for which a large amount of heat may be more directly absorbed by the blanket 110 and night periods for which heat release into the attic space 175 from the blanket 110 may occur. This is further facilitated by the direct exposure of the blanket 110 to the attic space 175 in absence of insulation or other materials to the exterior of the blanket 110. For one embodiment in particular, the top surface of the blanket 110 illustrated at the ceiling 170 is intentionally kept substantially free of any insulation material.

As detailed in 10,487,496, incorporated herein by reference in its entirety, a temperature modulating blanket 110 with suitable phase change material 140 (PCM) and architecture may be utilized to keep temperature swings in the facility space 125 to within a more limited and moderate range in spite of the more dramatic temperature swings in the attic space 175. However, apart from the dramatic temperature swings overtime, during daylight hours and soon thereafter, the attic space 175 is also prone to present a dramatic variance in temperature across the height of the attic space 175. This means that the ductwork 160 is not only positioned in a location of potentially dramatic temperature swings but that during the higher temperature periods, the ductwork 160 is prone to exposure to dramatically different temperatures at the same moment in time. For example, with respect to the temperature gradient between points (A) and (B) illustrated in FIG. 1B, there may more than a 50° F. difference in temperature as described below.

The elevated temperature of the attic space 175 is prone to have an adverse impact on the flow of conditioned air through the ductwork channel 180. However, the severity of the gradient may also have an impact on this airflow. For example, if left in absence of a blanket 110, the underlying ductwork 160 is prone to develop a hotter region at more elevated locations closer to point (A) and a comparatively cooler region at lower elevations closer to point (B) (see FIG. 1B). As a result, the airflow through the channel 180 is in constant exposure to a portion of the ductwork 160 that is continuously hotter, thereby ensuring an inefficiency. That is, as opposed to an even distribution of exposure to a ductwork structure 160 of consistent temperature, a hotter side is presented that assures a consistent exposure to a higher temperature and an accordingly increased delta or temperature disparity which tends to increase heat flow to the ductwork. However, with an architecture of ductwork 160 channeling comparatively cooler conditioned air that is covered or wrapped by the PCM blanket 110, this delta is reduced. As described below, this reduction may translate into no more than a degree of difference throughout the ductwork 160. Additional benefits such as reduced turbulence of the airflow itself may also be realized.

With more direct added reference to FIG. 1B, walls 135 of the facility 190, or, as is the focus of the present embodiments, attic 175 positioned ductwork 160, may be outfitted with additional temperature modulating blankets 110. In contrast to the potential temperature differential at either side of a horizontally oriented ceiling 170, a ductwork system 100 is generally one that displays a substantial profile. For example, the ductwork system 100 (or the underlying ductwork 160 itself) may be up to two feet or more in height from top to bottom, depending on the facility 190. Once more, due to attic positioning of the system 100, the profile of the ductwork 160 is likely to be on the larger side due to fewer architectural space constraints. Considering that the attic space 175 is not only prone to becoming quite hot during daytime hours, depending on the geographic location of the facility 190, the space 175 is also likely to present a substantial gradient of temperature.

Continuing with added reference to FIGS. 1A and 1B, note that the facility 190 includes a pitched roof 185. Although the roof 185 may be a raised flat roof, peaked at the center or of some other morphology, the pitch as illustrated helps to highlight the potential fora temperature gradient 155 between one elevated location (A) and a lowered location (B). For sake of illustration only, in an attic space 175 where a temperature modulating blanket 110 is located at the ceiling 170 as illustrated, in the middle of a hot summer day, it would not be unheard of for the temperature gradient to exceed 50° F. in the attic space 175 between the elevated (A) and lowered (B) locations, perhaps 155° F. at one (A) and 100° F. at the other (B). Of course, these numbers are only illustrative and may vary depending on a variety of factors such as overall daytime heat of the geographic location.

The gradient of heat 155 in the attic space 175 described above, presents a unique issue to ductwork 160 and system 100 that is installed in the attic space 175 and is of a substantial profile or height 150 as described above. That is, even apart from the issue of the attic space 175 becoming generally hot during daylight hours, there is the added issue of the temperature gradient 155 at any given moment depending on elevation, including of the ductwork 160 itself.

For the above examples, a gradient of heat 155 is described that may reach as high as 155° F. at higher elevations of the attic space 175. Of course, this is just exemplary. However, note that unlike insulation, the use of a phase change material blanket 110 means that heat within the attic space 175 is not isolated or partially sealed off to the attic space 175 above. Instead, heat is absorbed by the blanket 110. This means that the overall heat of the attic space 175 may be reduced. So, for example, where a conventional space 175 may be prone to display a heat as high as 175° F., it may be kept down to 155° F. or, where a maximum heat of 155° F. might be expected for a conventional space, the maximum may be kept down to 125° F. Of course, these numbers are, once again, only exemplary. Further, such results may be realized even where the use of the PCM blanket 110 is limited to the ductwork system 100, and potentially above the ceiling 170 as shown and described here.

However, in another embodiment, this concept of attic space 175 cooling through use of blankets 110 may be extended to securing of PCM blankets 110 at other attic space 175 locations, such as under the roof 180 or at interior wall 135 locations of the attic space 175. Recalling that a conventional insulation-based system tends to increase the R value, isolate heat within the attic space 175 and even drive it up, the opposite may be achieved with the present embodiments. Thus, the effect of attic space 175 cooling, may work synergistically with the PCM blanket 110 of the system 100. That is, the ability to maintain an efficient and consistently lower temperature airflow through the channel 180 in a non-turbulent manner may effectively be enhanced. As a result, ductwork losses are reduced, energy is saved and the life of the HVAC system facilitating the airflow through the channel 180 may be extended.

Returning to the ductwork system 100 more specifically with particular reference to FIG. 1B, the effect of a temperature gradient between locations (A) to (B) as illustrated is discussed in greater detail. Specifically, the blanket 110 of the system 100 may be utilized to help render a temperature gradient outside of the channel 180 negligible as to impact within the channel 180. More specifically, while an elevated location (A) adjacent the channel 180 may be dramatically higher than a lowered location (B) adjacent the channel, corresponding temperature disparity between an internal elevated location (a′) and an internal lowered location (b′) may be rendered negligible by the intervening blanket 110. More specifically, as detailed below, PCM 140 of the blanket 110 may be of a unique melting range of temperatures and serve as a medium through which temperatures external to the channel 180 are regulated.

In one embodiment, a thermally conductive layer 130 and/or reflective layer 201, in thermal communication with the PCM 140 is provided at the PCM 140 as part of the blanket 110 to help ensure that changes in temperature to the PCM 140, for example, during a melting thereof, is more evenly distributed. That is, where PCM 140 located nearest point (A) might otherwise be prone to melt in advance of PCM 140 nearer point (B), the thermal distribution is such that the PCM 140 is likely to melt in a relatively uniform manner. This means that the temperature gradient or disparity is substantially avoided as it relates to the channel 180. More specifically, in spite of the external dramatic temperature gradient in the attic 125, points (a′) and (b′) are exposed to substantially the same degree of external heat. By way of specific example, the underlying ductwork 160 will externally face an exposure to substantially identical temperatures whether the portion of the structure is closer to point (a′) or point (b′). This eliminates the possibility of turbulence being introduced within the channel 180 and avoids exposure of the airflow to a temperature gradient that varies from point to point. Indeed, the internal gradient between points (a′) and (b′) within the channel 180 or at the internal surface of the ductwork 160 will be under about 1° F., regardless of almost any practical temperature conditions of the surrounding attic space 175. This is the case even in absence of additional blanket 110 placement throughout other locations of the attic space 175 as also described above.

With a consistency in external heat presented to conditioned air within the channel 180, a more consistently reliable delivery of conditioned air may be presented to various rooms of the facility 190. An ecosystem of swirling or turbulent air having varying temperatures within a channel 180 may be largely avoided. Instead, a steady stream of conditioned air may be provided through the ductwork 160 even in spite of the ductwork 160 being of a substantial profile and placement within the attic space 175 as indicated.

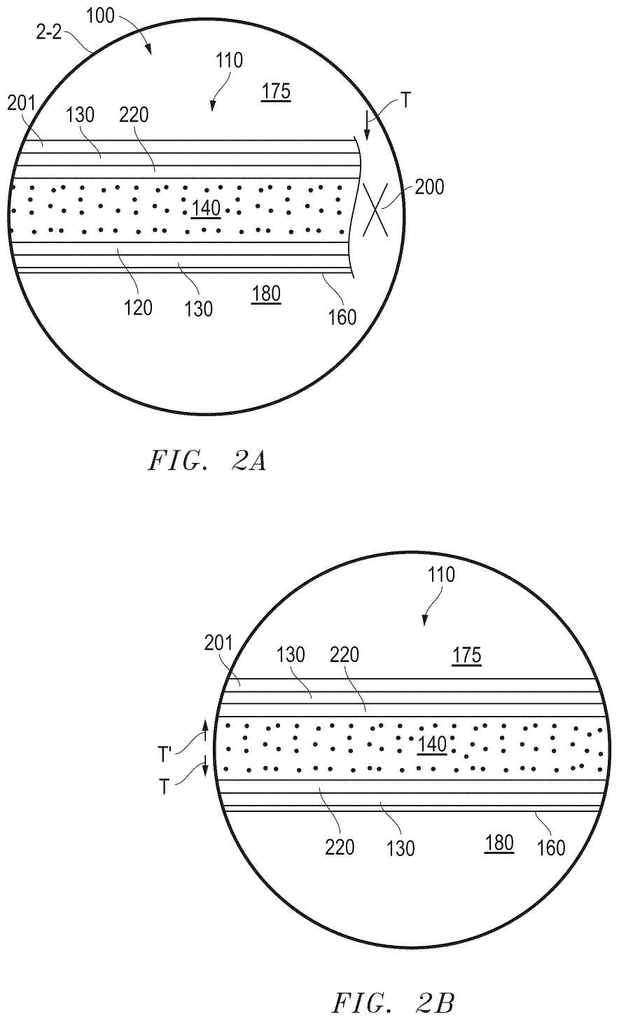

The schematic of FIG. 1B is simplified to illustrate a ductwork structure 160, accommodating a blanket 110 as described that includes PCM 140 as also described. Further, the blanket 110 includes a thermally conductive layer 130 as also noted above. However, as illustrated in FIGS. 2A and 2B, some added complexity may be provided to the blanket 110 architecture.

Referring now to FIG. 2A, a schematic cross-section of the temperature modulating blanket 110, taken from 2-2 of FIG. 1A is shown. In this depiction, the blanket 110 is exposed to attic temperatures above a melting point of the PCM 140. So, for example, as alluded to above, a scenario may emerge where daytime temperatures reach 100° F. which results in 120° F. or more adjacent the blanket 110 (e.g. in the adjacent space 175). Thus, heat flow, represented by (T) would tend to move in the downward direction of the arrow depicted. Of course, given the profile of the ductwork system 100, another heat flow of lesser heat, potentially from a lower sidewall location of the system 100 may also be moving in the direction of the channel 180. Regardless, the heat that does make it to the PCM material 140 is halted (e.g. see 200) (as it is absorbed throughout the day while the PCM 140 slowly transitions from solid-form to liquid). Further, in an embodiment where an outer reflective layer 201 is utilized, the flow of radiant heat may be substantially reduced or eliminated.

Continuing with specific reference to FIG. 2A, only at the point of complete liquification of the PCM 140 is the heat able to continue downward and fully cross the blanket 110 to the adjacent space below 180. However, keep in mind that for the circumstance of ductwork structure 160, this space 180 is generally utilized to channel conditioned cooled air during hotter daylight hours. This means that the PCM 140 is likely to remain charged, frozen or at least delayed in fully reaching a melted state, due to the adjacently flowing cooled air. For example, depending on HVAC settings, this conditioned air may be 55° F. when flowing through the ductwork 160 and likely to remain relatively cool, regardless, even when flow is not being forced through.

Referring now to FIG. 2B, a schematic cross-section of the temperature modulating blanket 110 of FIG. 2A is shown exposed to external temperatures that are below a melting point of the PCM 140. For example, as shown, the attic space 175 temperature is cooling down at the end of the day and is now below the 78° F. melting/freezing point temperature of the PCM 140 (e.g. perhaps at 70° F.). At this point in time, with the HVAC system ceasing to direct conditioned air through the channel 180 for a period, temperatures within the channel 180 may even be above that of the attic space 175 (e.g. depending on the hour of the evening, geographic location, etc.). The result may be an upward heat flow (T′) out of the PCM 140 and toward the attic space 175. To the extent that the PCM 140 has previously melted during the day, the PCM 140 may now begin to cool, freeze and recharge for the next day. Furthermore, as detailed above, the thermally conductive layer 130 of the blanket 110 is in thermally conductive communication with the PCM 140 (e.g. even in the embodiment illustrated with an intervening polymer layer 220, substantially air-free communication may be maintained). As a result, the rate of heat transfer from within the PCM 140 toward the attic space 175 (or to the channel 180) may be further enhanced. Thus, significant assistance to the complete freeze and recharge of the PCM 140 is provided over a given nighttime period. This is in sharp contrast to conventional radiant barriers that utilize an adjacent airspace to avoid conduction. Additionally, like the thermally conductive layer 130, the reflective layer 201 of the blanket 110 is also in conductive thermal communication with the underlying PCM 140 to ensure thermal conduction therewith and providing the same advantages of thermal conductivity. Unlike a more conventional construct, this type of layer 201 is not stapled to the roof of the attic nor provided with a small airspace to keep an insulating distance from the PCM 140. To the contrary, as with the thermally conductive layer 130, a substantially air-free conductive thermal communication with the PCM 140 allows for a more timely freezing of the PCM 140, for example, at night when temperature flow is in the opposite direction (e.g. out of the PCM 140 and into the cooler adjacent locations as illustrated in FIG. 2B).

Furthermore, along these lines, the reflective layer 201 is not only in in substantially air-free, conductive thermal communication with the PCM 140, but the material selected for the layer 201 is itself, a thermal conductor. That is, rather than employ a conventional biaxially-oriented polyethylene terephthalate such as Mylar® or other standard metalized polymer films with minimal thermally conductive K values, materials are selected with K values greater than about 0.15. Indeed, as used herein, materials with K values below about 0.15, such as Mylar®, are referred to as thermal insulators due to the propensity to impede thermal conductivity more so than facilitate such conductivity, particularly where any degree of thickness is employed. On the other hand, materials with a K value in excess of about 0.15 are considered thermal conductors. For example, an aluminum foil as mentioned above may display a K value in excess of 200 (e.g. at about 205). Once more, aluminum foil is readily available and workable from a manufacturing standpoint and therefore may be commonly selected, although in other embodiments, alternative thermal conductor materials (e.g. with K values above 0.15) may be employed for the reflective layer 201. Due to the particular material choices selected for the present embodiments, the reflective layer 201 serves the dual and opposite purposes of being both a reflective layer during daylight hours and facilitating thermal conductivity during cooling night hours.

With the above dynamics in mind and added reference to FIG. 1A, an embodiment where the ductwork system 100 is not entirely wrapped by the blanket 110 may be considered. For example, the system 100 with ductwork structure 160 (see FIG. 1B) may be installed at the ceiling 170 in advance of blanket 110 installation such as where the retrofit is in multiple stages with the first stage being an installation of ductwork 160 in the attic 175 and a later stage installation of the PCM blanket 110. Where this occurs, the installer may elect to place the blanket 110 across the ceiling 170 until interruption by the ductwork 160 leads to the installer raising and laying the blanket 110 over the ductwork 160, similar to placement of a rug over electrical wires across a floor as often takes place in a temporary stage environment. Note that where this occurs and the system 100 fails to include PCM blanket 110 entirely around the ductwork structure 160, a substantial benefit may nevertheless be realized. Specifically, with reference to the heated attic space 175 example above, recall that the increased temperature location is greater above the system 100. Once more, the system 100 is still surrounded by the blanket 110 in the sense that the entirety of the ductwork 160 is now forced below the blanket 110. Once more, while the profile of the blanket 110 is likely a bit different, it remains that the PCM 140 is still likely to present a substantially uniform melt and heat transfer capability for the reasons detailed hereabove. Thus, it remains that the ductwork 160 and channel 180 are protected from temperature extremes of the attic 175.

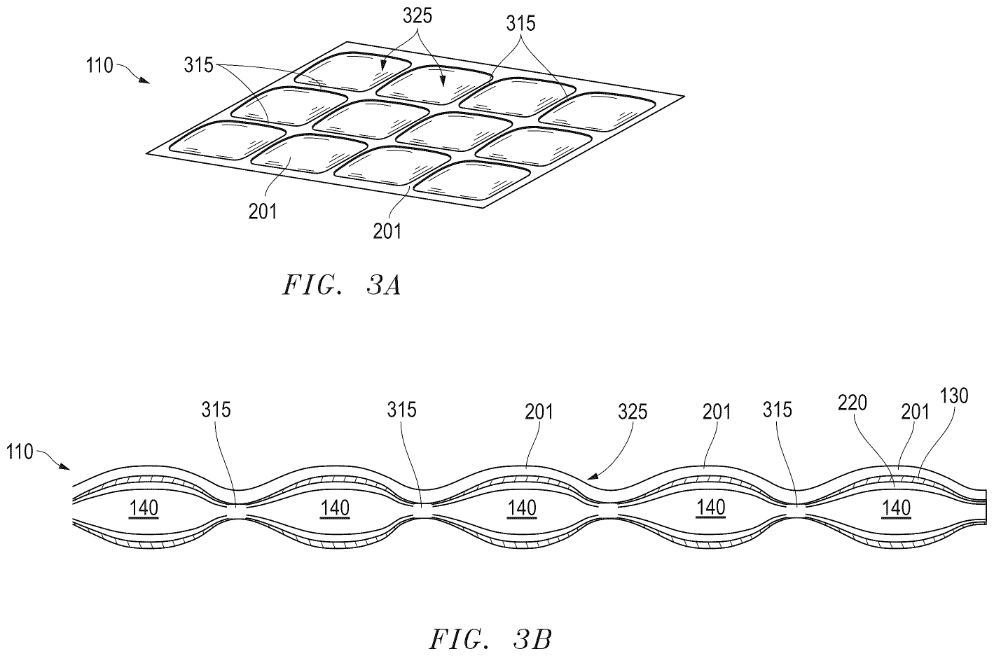

Referring now to FIGS. 3A and 3B, individual pods 325 of phase change material (PCM) 140 are provided between seams 115 to render the blanket 110. The particular PCM 140 displays characteristics similar to ice at between about 78°−82° F. in one embodiment. That is to say, the PCM 140 may be referred to as having a melting point of about 78° F. However, it should be noted that, just as with water-based ice, the melting or freezing of the PCM 140 is transitional and may occur over a given limited range of temperature, depending on factors such as purity, rate of heat transfer, etc. So, for example, as used herein, noting that the PCM 140 has a particular freezing or melting point (e.g. 78° F.) is not meant to infer that the PCM 140 wouldn't start to freeze at 79° F. or start to melt at 77° F., but rather that at 78° F., some transitional effects might be expected. Furthermore, while 78° F. is referenced herein as the exemplary melting point for the PCM 140, it should be noted that alternative material choices for the PCM 140 may be utilized that would result in a melting point of substantially greater than or less than 78° F. Even water may be an appropriate option for PCM 140 use. Regardless, the particular melting point for the selected PCM 140 may be tailored to the environment in which the blanket 110 is to be utilized and/or the range of temperature that is desired within the structural facility as discussed further below.

For the embodiment depicted in FIGS. 3A and 3B, the PCM 140 may be calcium chloride hexahydrate, sodium sulfate, paraffin, coconut oil or a variety of other materials selected that would display a predetermined melting point such as 78° F. Such materials may be described in greater detail within U.S. Pat. Nos. 5,626,936, 5,770,295, 6,645,598, 7,641,812, 7,703,254, 7,704,584 and 8,156,703, each of which are incorporated by reference herein in their entireties. Regardless of the particular material selected for the PCM 140, it may act like a solar collector, absorbing heat from the outside environment as it transitions from a “frozen” state to a liquid state as temperatures reach and exceed 78° F., in the example noted.

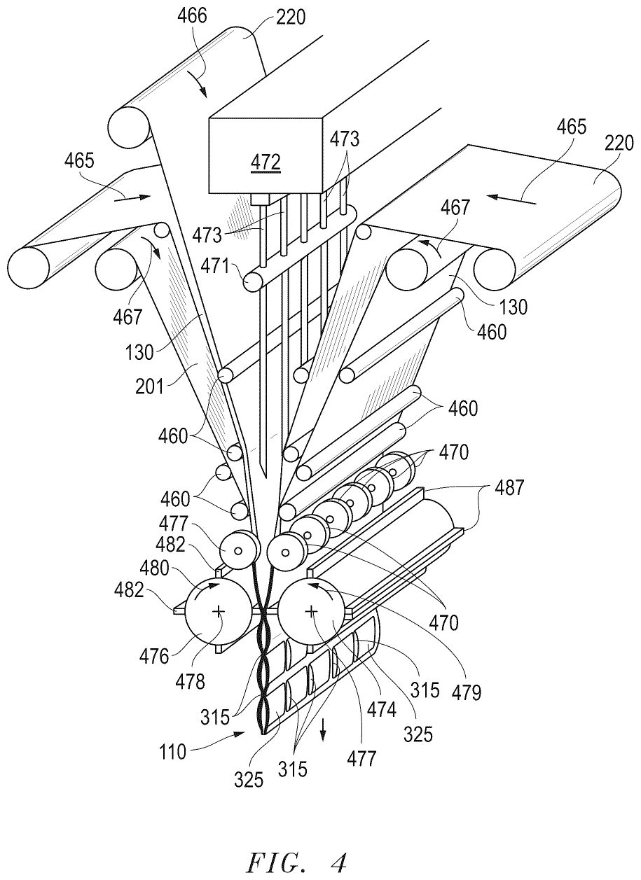

Referring now to FIG. 4, a perspective view of an embodiment of a manufacturing equipment for the reflective temperature modulating blanket 110 is shown. FIG. 4 illustrates a process by which the blanket 110 of FIGS. 1A-3B may be produced. As shown, multiple sheets or polymer layer plies 220, 130 are fed from their supplies from opposite sides and advanced along a processing path in a downward direction as indicated by arrows 465-467. Furthermore, at one side, an additional ply of a reflective layer 201 is incorporated into the process. Various guide rolls 460 guide the plies 220, 130, 201 until they pass in superposed relationship between opposed gangs of longitudinal heated sealing wheels 470, 471. The sets of wheels 470, 471 are urged toward one another, with the plies 220, 130, 201 passing there between. As the wheels 470, 471 make contact with the plies 220, 130, 201, at least the polymer plies 120, 130 fuse, forming seams 315. This effects the formation of pockets which ultimately help to define the illustrated pods 325.

In the meantime, laterally extending sealing drums 474 and 476 are rotatable about their laterally extending axes 477 and 478 in the directions as indicated by arrows 479 and 480, and the laterally extending ribs 481 of the sealing drum 474 register with the laterally extending ribs 482 of the sealing drum 476. The sealing drums 474 and 476 are heated, and their ribs 482 are heated, to a temperature that causes at least the polymer plies 220, 130 advancing along the processing path to fuse in response to the contact of the ribs 481 and 482. In this manner, lateral seams 315 are formed in the superposed sheets, closing the pods with PCM 140 therein as discussed above (see also FIG. 3B).

With added reference to FIG. 3B, the center of the formed pods 325 are filled with PCM 140, such as calcium chloride hexahydrate, sodium sulfate, paraffin, Na₂SO₄·10H₂O, CACl₂6H₂O, Na₂S₂O₃·5H₂O, NaCO₃·10H₂O, NaHPO₄·12H₂O or a variety of other materials having melting/freezing points of somewhere between about 60° F. and 85° F. Regardless, as shown in FIG. 4, these materials may be stored in a material housing 472 and metered out during the above described pod forming process. More specifically, tubular dispensers 473 from the housing 472 may be used to deliver a predetermined amount of PCM 140 to each pod in between each sealing closure with the ribs 482 which closes off each pod 325. While FIG. 4 shows an example of the possible apparatus that can be used to produce the blanket 110 of FIG. 3B, other conventional filling devices may be used as may be convenient and appropriate.

The reflective layer 201 that is added to the process in FIG. 4 and well-illustrated in FIG. 2A, may be a conventional aluminum foil or other reflective material as discussed further herein that serves as a barrier to minimize moisture and block thermal radiation. That is, while during use, heat may still travel through thermal conduction and convection, the presence of the reflective layer 201 substantially reduces or eliminates thermal radiation as a means of heating the PCM 140. Therefore, even in the face of adjacent extreme temperatures, the rate of melt to the PCM 140 may be minimized, thereby protecting the underlying space from heat transfer for the substantial portion of the day.

Returning to reference to FIG. 4 with added reference to FIGS. 3A and 3B, from a manufacturing and user friendliness standpoint, an array of pods 325 containing PCM 140 provides a practical way of handling the blanket 110 as opposed to say a multilayered structure lacking seam 315 support. Also, recall that the blanket 110 functions differently than conventional insulation. That is, the temperature of the blanket 110 acts to absorb heat as described above. Thus, seams 315 lacking PCM 140 do not compromise the overall effectiveness of the blanket 110 in modulating temperature. In fact, recall that the outer reflective layer 201 is in conductive thermal communication with the underlying PCM 140. Apart from other unique advantages, this temperature conduction capability further ensures that temperatures across the blanket 110 may be substantially uniform and distributed. For ductwork 160 wrapped in this type of a structure, the minimizing of temperature variability in this manner may be of substantial benefit as described above. Indeed, with this type of distributed thermal conduction, the limiting of the variance even carries over for example, from some locations that include PCM 140 (e.g. 325) to others that do not (e.g. 315). Of course, mean temperature is also minimized in this manner.

While the reflective layer 201 is in conductive thermal communication with the PCM 140 of each pod 325, it may not necessarily be in direct contact with the material 140. For example, in the embodiment shown, different polymer layers 220, 130 may be utilized. Using these layers 120, 130 may serve as an aid to effectively sealing and forming the seams 315 during manufacture (e.g. see FIG. 4). In one embodiment, one or both of these layers 220, 130 may be substituted with a commercially available adhesive tape which is thermally conductive as defined herein. Regardless, at the reflective layer 201 side of the blanket 110, the reflective layer is kept in substantially direct uniform contact with the adjacent polymer layer 130 which is in direct contact with the next layer 220 about the PCM 140. For the embodiments shown, these layers may be of PTFE or other polyethylene films that are also thermally conductive as defined herein with K values above about 0.15 as described above. Thus, due to the substantially air-free contact throughout, the reflective layer 101 is effectively in thermally conductive thermal communication with the PCM 140.

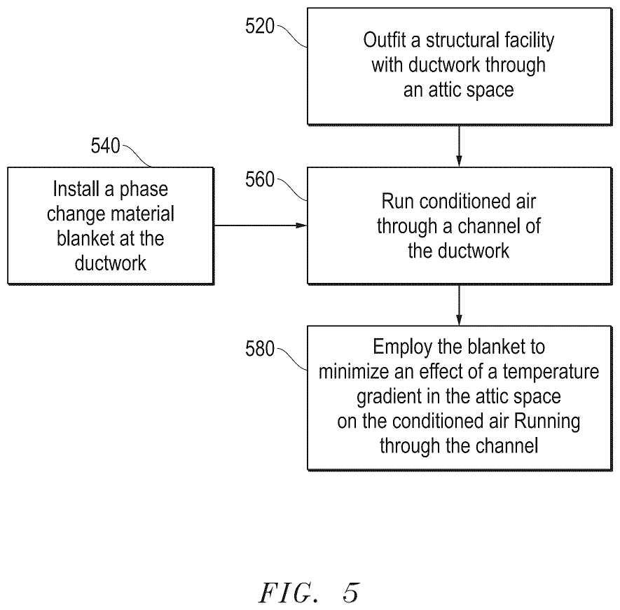

Referring now to FIG. 5, a flow-chart is shown summarizing an embodiment of incorporating a temperature modulating blanket into a ductwork system installed within an attic space for minimizing the effect of attic temperature gradient on conditioned air run through the ductwork. This may be likely to come up in the circumstance of retrofitting a facility with a central air conditioning system which often includes installing ductwork through attic space as indicated at 520. As noted at 540, a phase change material blanket may then be installed at this ductwork and conditioned air run through a channel of the ductwork (see 560). Thus, even though the attic space may be prone to display highly elevated temperatures as well as a potentially dramatic temperature gradient, as indicated at 580, the blanket may be utilized to minimize the impact of this temperature gradient on the adjacent conditioned air of the ductwork.

Embodiments described hereinabove include a ductwork system that is capable of installation in an attic space without undergoing significant losses due to surrounding attic air prone to excessive heat and heat gradient exposure during daylight hours. This may be achieved in a manner that does not require reinstallation of new ductwork hardware or other extensive or labor intensive measures. Once more, the ductwork system embodiments employ temperature modulating blankets that may be utilized with other architectural features, such as ceiling placement. Thus, the ductwork system may be provided simultaneously and in conjunction with other related improvements also being undertaken.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. For example, while HVAC size and power capacity are not necessarily the focus of the present embodiments, utilizing ductwork system embodiments detailed herein may have positive impacts on HVAC's utilized. By way of example, a power output drop of more than 10% may be expected where such embodiments are utilized, such as where a 4-ton unit servicing a 2,500 sq. ft. home is effectively replaced with a 3-ton unit when the ductwork system embodiments herein are utilized. Furthermore, the foregoing description should not be read as pertaining only to the precise structures described and shown in the accompanying drawings, but rather should be read as consistent with and as support for the following claims, which are to have their fullest and fairest scope.

I claim:

1. A method of cooling a facility space below a ceiling, the method comprising:
installing ductwork in an attic space above the ceiling, the attic space to display a vertical delta temperature disparity;
positioning a phase change material blanket about the ductwork;
flowing conditioned air through the ductwork at a temperature below that of a temperature outside of the facility space;
absorbing heat from the attic space with the phase change material blanket;
melting phase change material of the blanket by the absorbing for reducing exposure of the ductwork to attic space heat to minimize a delta disparity of temperature to the flowing of the conditioned air;
delivering the conditioned air from the ductwork to the facility space below.

2. The method of claim 1 further comprising reducing a mean temperature of the attic space and the vertical temperature gradient of the attic space with another phase change material blanket exposed to the attic space and positioned at one of a top surface of the ceiling, a wall of the facility and a roof of the facility.

3. The method of claim 1 wherein the reducing of the exposure of the ductwork to the heat of the attic space translates to a delta disparity of less than about 1° F. at the ductwork.

4. The method of claim 1 further comprising refreezing the phase change material after the melting when the temperature outside of the facility space drops.

5. The method of claim 1 wherein the melting of the phase change material is in a substantially uniform manner through the blanket in response to the absorbing of the heat from the attic space.

6. The method of claim 5 wherein the substantially uniform melting of the phase change material is facilitated in part by one of a thermally conductive and a reflective layer in substantially air-free thermally conductive communication therewith.

7. The method of claim 1 wherein the structural facility is retrofitted with the ductwork after initial facility use.

8. The method of claim 6 wherein the phase change material blanket is retrofitted on the ductwork after use of the facility with flowing conditioned air.

9. A ductwork system for cooling a facility space below a ceiling, the system comprising:
ductwork in an attic space above the ceiling to accommodate conditioned air flowing at a temperature below that of a temperature outside of the facility, the attic space to display an elevated vertical temperature gradient; and
a phase change material blanket about an exterior of the ductwork, the blanket comprising a phase change material to absorb heat from the attic space to minimize a delta disparity of temperature to the flowing of the conditioned air.

10. The ductwork system of claim 9 wherein the temperature modulating blanket is wrapped substantially around an entirety of an outer surface of the ductwork.

11. The ductwork system of claim 9 further comprising one of the phase change material blanket and another phase change material blanket positioned on an upper surface of the ceiling.

12. The ductwork system of claim 9 wherein the phase change material is selected from a group consisting of water, calcium hexahydrate, calcium chloride hexahydrate, sodium sulfate, paraffin, coconut oil, Na₂SO₄·10H₂O, CACl₂6H₂O, Na₂S₂O₃·5H₂O, NaCO₃·10H₂O and NaHPO₄·12H₂O.

13. The ductwork system of claim 9 wherein the phase change material blanket further comprises one of a thermally conductive layer and a reflective layer over the phase change material and in substantially air-free, thermally conductive communication therewith.

14. The ductwork system of claim 13 wherein the one of the thermally conductive layer and the reflective layer are of a k value in excess of 0.15.

15. The ductwork system of claim 13 wherein the thermally conductive layer comprises one of a thermally conductive polymer and an adhesive tape.

16. The ductwork system of claim 13 wherein the reflective layer is aluminum foil.

17. A structural facility with a facility space below a ceiling that is of a temperature below that of an attic space above the ceiling, the facility comprising:
ductwork in the attic space, the attic space to display an elevated vertical temperature gradient, the ductwork defining a channel to accommodate a flow of conditioned air at a temperature below that of a temperature outside of the facility space;
a phase change material blanket about an exterior of the ductwork, the blanket comprising a phase change material to absorb attic space heat for minimizing a delta disparity of temperature to the flowing of the conditioned air.

18. The structural facility of claim 17 wherein the elevated vertical temperature gradient is in excess of 50° F.

19. The structural facility of claim 9 further comprising one of a roof and a wall defining the attic space, at least one of the roof and the wall and accommodating another phase change material blanket exposed to the attic space.

20. The structural facility of claim 9 wherein the temperature modulating blanket is installed at an upper surface of the ceiling and around a portion of the ductwork.
